(19) United States
(12) Patent Application Publication
(10) Pub. No.: US 2020/0050128 A1
(43) Pub. Date: Feb. 13, 2020

(54) INFORMATION PROCESSING APPARATUS AND IMAGE FORMING APPARATUS

(71) Applicant: CANON KABUSHIKI KAISHA, Tokyo (JP)

(72) Inventor: Junichi Goda, Kashiwa-shi (JP)

(21) Appl. No.: 16/529,301

(22) Filed: Aug. 1, 2019

(30) Foreign Application Priority Data
Aug. 10, 2018 (JP) 2018-152000

(51) Int. Cl. G03G 15/043

(52) U.S. Cl. CPC G03G 15/043

(57) ABSTRACT

An image forming apparatus includes a laser scanner unit configured to deflect a laser beam with a reflection surface of a polygon mirror to scan a photosensitive drum, an engine controller, and an image controller. The engine controller generates an image formation BD signal synchronized with a BD signal output from the laser scanner unit. The image controller masks an assertion period of the image formation BD signal, and determines a specific reflation face based on the masked assertion period. The image controller sets a mask period of the image formation BD signal at the time of the specific reflation face to be longer than a mask period at the time of another reflation face. The image controller corrects image data based on the identified reflection face to control image forming processing.

### BACKGROUND OF THE INVENTION

### Field of the Invention

The present disclosure relates to an information processing apparatus configured to correct image data to transmit the image data to an image forming apparatus, and to an image forming apparatus to which the information processing apparatus is connected.

### Description of the Related Art

For an electrophotographic image forming apparatus in which a laser beam is used, there has been known a configuration in which a laser beam deflected by a rotating polygon mirror scans a photosensitive member, to thereby form an electrostatic latent image on the photosensitive member.

The polygon mirror includes a plurality of reflection faces, and each reflection face sequentially deflects the laser beam. A shape of such a reflection face of the polygon mirror differs from one reflection face to another. When the shape of the reflection face differs from one reflection face to another, an electrostatic latent image formed on the photosensitive member by the laser beams deflected by the respective reflection faces is disadvantageously deformed.

In U.S. Pat. No. 9,575,314 B2, there is disclosed a configuration in which an image controller identifies a reflection face of a polygon mirror on which a laser beam is deflected (the image controller performs face identification) based on a time interval between adjacent pulses of an input main-scanning synchronization signal.

Specifically, the image controller performs processing involving measuring a time interval between adjacent pulses and identifying a reflection face corresponding to each pulse based on a measurement result. The image controller performs, on the image data, correction corresponding to each reflection face (correction of a writing position of an image, for example). Image formation is performed based on the corrected image data.

In U.S. Pat. No. 9,575,314 B2, when noise occurs in the main-scanning synchronization signal, the image controller may not be able to accurately identify a reflection face of the polygon mirror. When a reflection face of the polygon mirror is not accurately identified, appropriate correction corresponding to each reflection face is not performed, and the formed electrostatic latent image may thus be deformed. Therefore, the present disclosure has a main object to determine a reflection face with high accuracy.

### SUMMARY OF THE INVENTION

An information processing apparatus connected to an image forming apparatus including an image forming unit of the present disclosure includes: the image forming unit comprising: a first receiver configured to receive image data; a light source configured to output light based on the image data received by the first receiver; a photosensitive member; a rotary polygon mirror having a plurality of reflection faces, wherein the rotary polygon mirror is configured to rotate to deflect the light output from the light source through use of the plurality of reflection faces, to thereby scan the photosensitive member; a light receiver configured to receive the light deflected by the rotary polygon mirror; an identifier configured to identify a reflection face that is used for scanning of the photosensitive member from among the plurality of reflection faces based on a result of the reception of the light by the light receiver; and a generator configured to generate a first signal including a signal having a first level and a signal having a second level, wherein the generator is configured to generate the first signal based on information related to the reflection face identified by the identifier such that a length of a first period differs from a length of a second period, the first period being a period in which the first signal corresponding to a specific reflection face from among the plurality of reflection faces is at the first level, and the second period being a period in which the first signal corresponding to a reflection face other than the specific reflection face is at the first level, the information processing apparatus comprising: a second receiver configured to receive the first signal; a first detector configured to detect a first change, in which a level of the first signal received by the second receiver is changed from the second level to the first level; a second detector configured to detect a second change, in which the level of the first signal received by the second receiver is changed from the first level to the second level; a determiner configured to determine, based on a first timing, at which the first change is detected, and a second timing, at which the second change is detected first after a predetermined time period has passed since the first timing, whether the first change at the first timing is a change corresponding to the specific reflection face, wherein the predetermined time period is shorter than the length of the first period and the length of the second period; a corrector configured to correct, based on a determination result obtained by the determiner, image data corresponding to a scanning line of the light, through use of correction data corresponding to the reflection face corresponding to the scanning line; and a first output unit configured to output the image data corrected by the corrector to the image forming unit in response to the first detector detecting the first change.

Further features of the present invention will become apparent from the following description of exemplary embodiments (with reference to the attached drawings).

### BRIEF DESCRIPTION OF THE DRAWINGS

FIG. 1 is a diagram for illustrating a configuration of an image forming apparatus according to at least one embodiment of the present disclosure.

FIG. 2 is a diagram for illustrating an image corresponding to one surface of a recording medium.

FIG. 3 is a block diagram for illustrating a configuration of a laser scanner unit.

FIG. 4A and FIG. 4B are each a diagram for illustrating an example of a relationship between a BD signal and a face number of a reflection face.

FIG. 5 is a timing chart for illustrating a relationship between various signals and a counted number.

FIG. 6 is a flow chart for illustrating control to be performed by an engine controller.

FIG. 7 is a diagram for illustrating a configuration of an image processor.

FIG. 8 is a timing chart for illustrating a first mask signal and a second mask signal.

FIG. 9 is a flow chart for illustrating processing for mask signals.

FIG. 10 is a flow chart for illustrating control to be performed by the image controller.

### DESCRIPTION OF THE EMBODIMENTS

In the following, a preferred embodiment of the present disclosure is described with reference to the drawings. However, shapes of components described in this embodiment, and their relative positions and the like are subject to an appropriate change in accordance with a configuration and various conditions of an apparatus to which the present disclosure is applied. Accordingly, it is not intended to limit the scope of the present disclosure only to the following embodiment.

### Overall Configuration

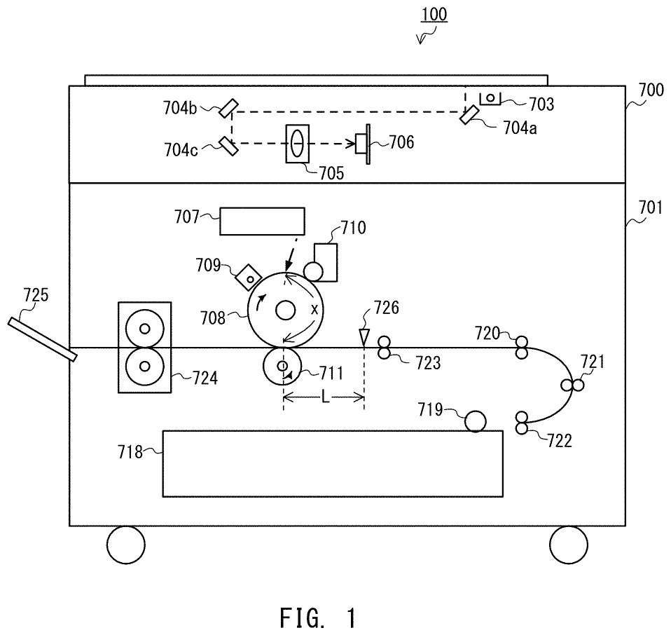

FIG. 1 is a cross-sectional view for illustrating a configuration of a monochrome electrophotographic copying machine (hereinafter referred to as “image forming apparatus”) 100. The image forming apparatus 100 is not limited to a copying machine, and may also be, for example, a facsimile machine, a printing machine, or a printer. Further, the image forming apparatus 100 may be any of a monochrome type and a color type.

In the following, the configuration and functions of the image forming apparatus 100 are described. As illustrated in FIG. 1, the image forming apparatus 100 includes an image reading apparatus (hereinafter referred to as “reader”) 700 and an image printing apparatus 701.

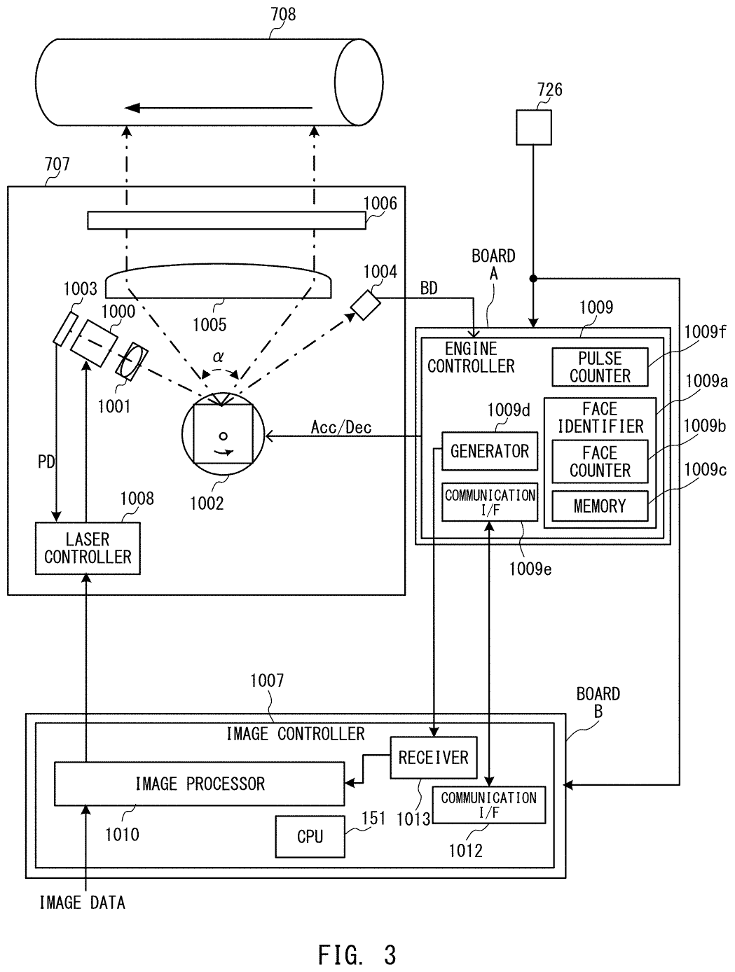

An illumination lamp 703 applies light to an original at a reading position of the reader 700. The light reflected from the original is guided to color sensors 706 by an optical system including reflection mirrors 704a, 704b, and 704c and a lens 705. The reader 700 reads the light that has entered the color sensors 706 for each of colors of blue (hereinafter referred to as “B”), green (hereinafter referred to as “G”), and red (hereinafter referred to as “R), and converts the read light into electrical image signals. The reader 700 performs color conversion processing based on intensities of the B, G, and R image signals, to thereby generate image data. The reader 700 outputs the generated image data to an image controller 1007 (see FIG. 3) described later.

A sheet receiving tray 718 is provided in the image printing apparatus 701. Each recording medium received in the sheet receiving tray 718 is fed by a feed roller 719, and is sent to registration rollers 723 in a stopped state by conveyance rollers 722, 721, and 720. A leading edge of the recording medium conveyed by the conveyance rollers 720 in a conveyance direction abuts against a nip portion of the registration rollers 723 in the stopped state. When the conveyance rollers 720 further convey the recording medium under the state in which the leading edge of the recording medium abuts against the nip portion of the registration rollers 723 in the stopped state, the recording medium bends. As a result, an elastic force acts on the recording medium, and the leading edge of the recording medium abuts along the nip portion of the registration rollers 723. In the above-mentioned manner, skew feeding of the recording medium is corrected. After skew feeding of the recording medium is corrected, the registration rollers 723 start conveyance of the recording medium at timing described later. The recording medium is a medium on which an image is to be formed by the image forming apparatus 100, and examples of the recording medium include a sheet of paper, a resin sheet, a piece of cloth, an OHP sheet, and a label.

The image data obtained by the reader 700 is corrected by the image controller 1007, and input to a laser scanner unit 707 including a laser light source and a polygon mirror that is a rotary polygon mirror. The photosensitive drum 708 has its outer peripheral surface charged with electricity by a charging device 709. After the outer peripheral surface of the photosensitive drum 708 is charged with electricity, the laser scanner unit 707 applies a laser beam based on the image data onto the outer peripheral surface of the photosensitive drum 708. As a result, an electrostatic latent image is formed on a photosensitive layer (photosensitive member) covering the outer peripheral surface of the photosensitive drum 708. A configuration for forming the electrostatic latent image on the photosensitive layer by the laser beam is described later.

Subsequently, the electrostatic latent image is developed by toner contained in a developing device 710, to cause a toner image to be formed on the outer peripheral surface of the photosensitive drum 708. The toner image formed on the photosensitive drum 708 is transferred onto the recording medium by a transfer charging device 711 arranged at a position (transfer position) opposed to the photosensitive drum 708. The registration rollers 723 send the recording medium to the transfer position at such timing as to enable the toner image to be transferred at a predetermined position of the recording medium. A sheet sensor 726 configured to detect a recording medium being conveyed is arranged between the registration rollers 723 and the transfer position.

The recording medium on which the toner image has been transferred is conveyed to a fixing device 724, and is heated and pressurized by the fixing device 724. As a result, the toner image is fixed. The recording medium to which the toner image has been fixed is delivered to a delivery tray 725 provided outside the image forming apparatus 100.

In the above-mentioned manner, the image is formed on the recording medium by the image forming apparatus 100. The above is the description of the configuration and functions of the image forming apparatus 100.

### Configuration for Forming Electrostatic Latent Image

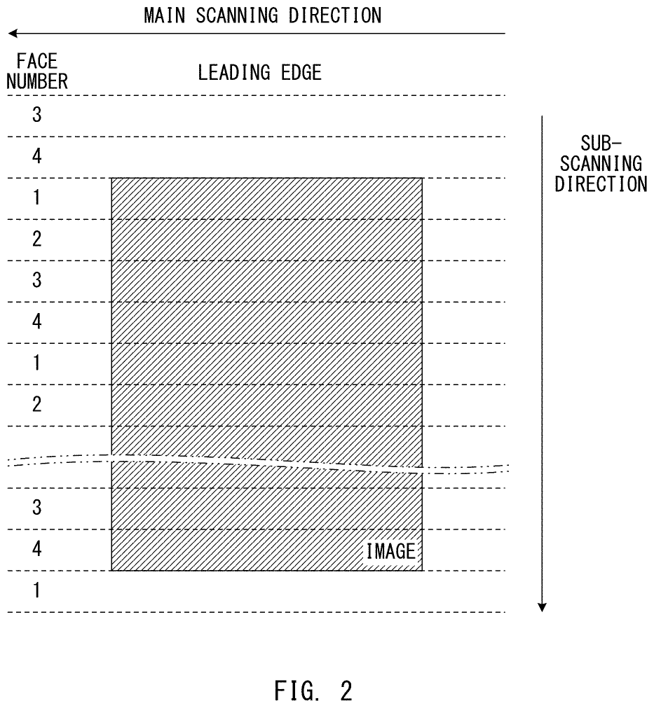

FIG. 2 is a diagram for illustrating an image corresponding to one surface of the recording medium. A face number illustrated in FIG. 2 is a number indicating each of a plurality of reflection faces of the polygon mirror described later. In this embodiment, the polygon mirror has four reflection faces.

A laser beam deflected by one reflection face scans the photosensitive layer in an axial direction of the photosensitive drum 708 (in a main scanning direction), to thereby form an image (electrostatic latent image) corresponding to a single time of scanning (corresponding to one line) on the photosensitive layer. The electrostatic latent image corresponding to one surface of the recording medium is formed on the photosensitive layer when scanning by the laser beam deflected by each reflection face of the polygon mirror is repeatedly performed in a direction of rotation of the photosensitive drum 708 (in a sub-scanning direction).

In the following description, data on an image corresponding to the electrostatic latent image corresponding to one line is referred to as “image data”.

### Laser Scanner Unit

FIG. 3 is a block diagram for illustrating a configuration of the laser scanner unit 707 in this embodiment. In the following, the configuration of the laser scanner unit 707 is described. An engine controller 1009 and the image controller 1007 control the operation of the laser scanner unit 707. The image controller 1007 corresponds to an information processing apparatus according to at least one embodiment of the present disclosure. In this embodiment, a board A, on which the engine controller 1009 is mounted, is a board different from a board B, on which the image controller 1007 is mounted. The board A, on which the engine controller 1009 is mounted, is coupled (connected) by a cable to the board B, on which the image controller 1007 is mounted.

The laser scanner unit 707 includes a laser light source 1000, a collimator lens 1001, a polygon mirror 1002, a photodiode (PD) 1003, a beam detect sensor 1004, an F-θ lens 1005, and a reflection mirror 1006. The beam detect sensor 1004 is hereinafter referred to as “BD sensor” 1004. The laser scanner unit 707 includes a laser controller 1008 configured to control light emission of the laser light source 1000 in accordance with image data input from the image controller 1007.

The laser light source 1000 emits laser beams in two directions with a light emitting element. The laser beam emitted from the laser light source 1000 in one of the directions enters the photodiode 1003. The photodiode 1003 converts the incident laser beam into an electrical signal, and transmits the electrical signal to the laser controller 1008 as a PD signal. The laser controller 1008 controls, based on the PD signal, an amount of light to be output from the laser light source 1000 (performs auto power control (APC)) such that a light amount of the laser beam becomes a predetermined light amount. In this case, general APC is performed, and hence a detailed description thereof is omitted.

The laser beam emitted from the laser light source 1000 in the other one direction is applied onto the polygon mirror 1002 via the collimator lens 1001. The polygon mirror 1002 has a plurality of reflection faces, and is rotationally driven by a polygon motor (not shown). As described above, the polygon mirror 1002 in this embodiment has four reflection faces. The polygon motor rotationally drives the polygon mirror 1002 in accordance with a motor drive signal (Acc/Dec) output from the engine controller 1009.

The laser beam applied to the polygon mirror 1002 is deflected toward a direction of the photosensitive drum 708 by one of the reflection faces. When the polygon mirror 1002 is rotated, a deflection angle of the laser beam changes. Through a change in deflection angle, the laser beam scans the photosensitive drum 708 in one direction. In this embodiment, the laser beam scans the photosensitive drum 708 from the right side to left side of FIG. 3. The laser beam has its optical path corrected by the F-θ lens 1005 so as to scan the photosensitive drum 708 at constant speed, and is applied onto the photosensitive drum 708 via the reflection mirror 1006.

The laser beam deflected by the polygon mirror 1002 is received by the BD sensor 1004. The BD sensor 1004 in this embodiment is a detector arranged at such a position as to be able to detect a laser beam before the laser beam starts scanning of the photosensitive drum 708. Specifically, for example, as illustrated in FIG. 3, the BD sensor 1004 is arranged in a region that is a part of a region through which the laser beam reflected by the polygon mirror 1002 passes, and that is outside a region expressed by an angle α and is located on an upstream side in the scanning direction of the laser beam (in the main scanning direction).

The BD sensor 1004 generates a BD signal having a first level and a second level based on the detected laser beam, and transmits the BD signal to the engine controller 1009. The BD signal is a detection signal that has, for example, the first level (Low) while the BD sensor 1004 is detecting the laser beam, and the second level (High) while the BD sensor 1004 is not detecting the laser beam. The engine controller 1009 controls the polygon motor based on the obtained BD signal such that a rotation cycle of the polygon mirror 1002 reaches a predetermined cycle. When the cycle of the BD signal has reached the predetermined cycle, the engine controller 1009 determines that the rotation cycle of the polygon mirror 1002 is stable at the predetermined cycle. That is, the engine controller 1009 adjusts the motor drive signal based on the BD signal, to thereby perform feedback control such that the rotation of the polygon mirror 1002 is stable at the predetermined cycle.

The engine controller 1009 transmits to the image controller 1007 an image formation BD signal serving as a synchronization signal for the BD signal. The BD signal and the image formation BD signal are each a signal indicating one scanning cycle at which the laser beam scans the photosensitive drum 708. When the rotation of the polygon mirror 1002 has become stable (when the rotation cycle has reached the predetermined cycle), the engine controller 1009 uses the generator 1009d to generate an image formation BD signal, and transmits the image formation BD signal to the image controller 1007.

When the sheet sensor 726 detects the recording medium, the conveyance of which is resumed, the sheet sensor 726 notifies the engine controller 1009 and the image controller 1007 of detection of the recording medium. The image controller 1007 corrects the image data based on information on an identified reflection face. Upon receiving the notification of detection of the recording medium from the sheet sensor 726, the image controller 1007 transmits to the laser controller 1008 the corrected image data for causing the laser light source 1000 to emit the laser beam, in synchronization with the image formation BD signal. That is, the image controller 1007 uses the image formation BD signal as a timing signal for outputting the image data. The laser controller 1008 controls light emission of the laser light source 1000 in accordance with the obtained image data. The laser light source 1000 is driven to be turned on and off under the control of the laser controller 1008, to thereby form an electrostatic latent image based on the image data on the photosensitive drum 708.

A distance L from a position at which the recording medium is detected by the sheet sensor 726 to the transfer position is longer than a distance x from a position on the outer peripheral surface of the photosensitive drum 708 at which the laser beam is applied to the transfer position in the rotation direction of the photosensitive drum 708. Specifically, the distance L has a length obtained by adding the distance x to a distance for which the recording medium is conveyed during a period from when the sheet sensor 726 detects the recording medium until the laser beam is emitted from the laser light source 1000. During the period from when the sheet sensor 726 detects the leading edge of the recording medium until the laser beam is emitted from the laser light source 1000, the image controller 1007 corrects the image data and controls the laser controller 1008, for example.

### Face Identification Processing for Identifying Reflection Face of Polygon Mirror

The image controller 1007 outputs, in accordance with the cycle of the input image formation BD signal, the corrected image data to the laser controller 1008 in order from the most upstream piece of image data in the sub-scanning direction. The laser controller 1008 controls the laser light source 1000 in accordance with the input image data, to thereby form an image on the outer peripheral surface of the photosensitive drum 708. In this embodiment, the number of reflection faces of the polygon mirror 1002 is four, but the number is not limited to four.

The image to be formed on the recording medium is formed by the laser beams deflected by the plurality of reflection faces of the polygon mirror 1002. Specifically, for example, as illustrated in FIG. 2, an image corresponding to the most upstream piece of image data in the sub-scanning direction is formed by a laser beam deflected by a first face of the polygon mirror 1002. Further, an image corresponding to the second most piece of upstream image data in the sub-scanning direction is formed by a laser beam deflected by a second face of the polygon mirror 1002, which is different from the first face. In the manner described above, the image formed on the recording medium is formed of images formed by the laser beams reflected in order by the plurality of respective reflection faces of the polygon mirror 1002.

When the polygon mirror 1002 having four reflection faces is used, there is a possibility that an angle formed by adjacent two reflection faces is not accurately 90°. Specifically, there is a possibility that, when the polygon mirror 1002 having four reflection faces is viewed from the direction of its rotation axis, an angle formed by adjacent two sides is not accurately 90° (that is, the shape of the polygon mirror 1002 viewed from the direction of the rotation axis is not a square). When the polygon mirror having n (n is a positive integer) reflection faces is used, there is a possibility that the shape of the polygon mirror viewed from the direction of the rotation axis is not a regular n-gon.

When the angle formed by adjacent two reflection faces of the polygon mirror 1002 having four reflection faces is not accurately 90°, the position and size of the image formed by the laser beam differ from one reflection face to another. As a result, an image formed on the outer peripheral surface of the photosensitive drum 708 is deformed, and thus a deformed image is formed on the recording medium.

In view of the above, in this embodiment, correction (correction of a writing position, for example) based on a correction value (correction data) corresponding to each of the plurality of reflection faces of the polygon mirror 1002 is performed on the image data. In this case, a configuration for identifying a reflection face on which the laser beam is deflected is required. In the following, an example of a method of identifying a reflection face on which the laser beam is deflected is described. In this embodiment, a reflection face on which the laser beam is deflected (reflected) from among the plurality of reflection faces of the polygon mirror 1002 is identified by a face identifier 1009a provided in the engine controller 1009.

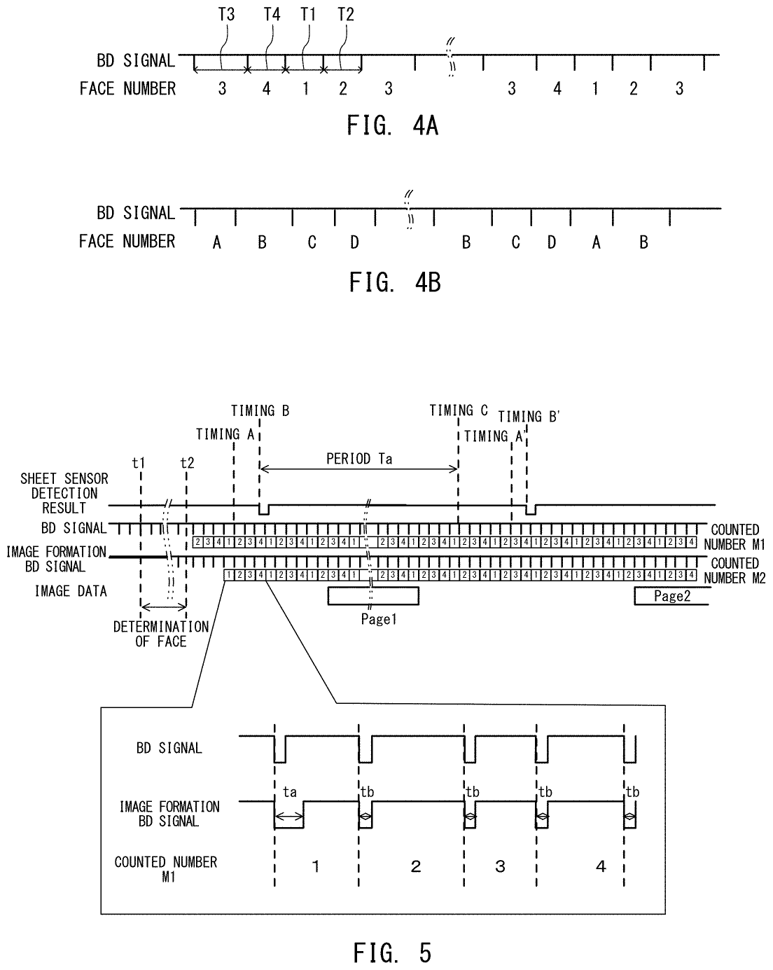

FIG. 4A is a diagram for illustrating an example of a relationship between a BD signal generated by a laser beam scanning a light receiving surface of the BD sensor 1004 and a reflection face on which the laser beam is deflected (face number thereof). As illustrated in FIG. 4A, a time period (scanning cycle) until a BD signal falls first after the BD signal rose subsequently to previous falling of the pulse of the BD signal differs from one reflection face of the polygon mirror 1002 to another. The scanning cycle corresponds to a time period from when the laser beam scans the light receiving surface of the BD sensor 1004 until the laser beam scans the light receiving surface again.

In FIG. 4A, a scanning cycle corresponding to a face number 1 is indicated by T1, a scanning cycle corresponding to a face number 2 is indicated by T2, a scanning cycle corresponding to a face number 3 is indicated by T3, and a scanning cycle corresponding to a face number 4 is indicated by T4. Each of the scanning cycles is stored in advance in a memory 1009c provided in the face identifier 1009a.

The face identifier 1009a uses the following method to identify a reflection face (face number) on which the laser beam is deflected. Specifically, as illustrated in FIG. 4B, the face identifier 1009a sets face numbers A to D for four successive scanning cycles of the BD signal. Then, the face identifier 1009a measures a scanning cycle for each of the face numbers A to D a predetermined number of times (for example, 32 times), and calculates an average value of the measured scanning cycles for each of the face numbers A to D.

The face identifier 1009a identifies, based on the average value of the calculated scanning cycles and the cycles T1 to T4 stored in the memory 1009c, which of the face numbers 1 to 4 corresponds to each of the face numbers A to D.

In the manner described above, the face identifier 1009a can identify the number of a reflection face on which the laser beam is deflected (reflection face that is used for scanning of the photosensitive drum 708 from among the plurality of reflection faces of the polygon mirror 1002) based on the input BD signal.

### Processing by Engine Controller

Next, control to be performed by the engine controller 1009 in this embodiment is described with reference to FIG. 3 and FIG. 5. As illustrated in FIG. 3, the face identifier 1009a includes a face counter 1009b. The face counter 1009b is configured to store face information indicating a reflection face on which the laser beam for scanning the light receiving surface of the BD sensor 1004 is deflected. FIG. 5 is a timing chart for illustrating a relationship between various signals and a counted number M1 of the face counter 1009b. The counted number M1 of the face counter 1009b corresponds to the face information.

When the rotation cycle of the polygon mirror 1002 has reached the predetermined cycle (time t1), the engine controller 1009 (face identifier 1009a) performs identification of a face number (determination of a face) by the method described above based on the input BD signal.

At a time t2, at which the face identifier 1009a finishes the identification (estimation) of the face number, the engine controller 1009 starts counting by the face counter 1009b. Specifically, when the identification of the face number is finished, the engine controller 1009 sets a face number corresponding to a BD signal that is input first after the identification of the face number is finished, as an initial value of the counted number M1 of the face counter 1009b. After setting the initial value of the counted number M1, for example, the engine controller 1009 updates the counted number M1 every time a falling edge of the input BD signal is detected. When the polygon mirror 1002 has n (n is a positive integer) reflection faces, M1 is a positive integer satisfying 1≤M1≤n.

After that, the engine controller 1009 notifies the image controller 1007 via a communication I/F 1009e that the determination of the reflection face is completed. After acquiring the notification from the engine controller 1009, a central processing unit (CPU) 151 outputs an instruction to execute printing (instruction to form an image on the recording medium) to the engine controller 1009 via the communication I/F 1012 (timing A). In response to the instruction, the engine controller 1009 starts drive of the registration rollers 723. The sheet sensor 726 detects the leading edge of the recording medium (timing B), the conveyance of which is resumed. The timing A is determined by the CPU 151 based on a time period for processing of the printing job input to the image forming apparatus 100. That is, the timing A is not limited to the timing illustrated in FIG. 5. Further, in this embodiment, the detection result obtained by the sheet sensor 726 illustrated in FIG. 5 reaching the low level indicates that the sheet sensor 726 has detected the leading edge of the recording medium.

When the determination of the reflection face is completed, a generator 1009d generates an image formation BD signal based on the face information on the reflection face identified by the face identifier 1009a and the BD signal output from the BD sensor 1004. Specifically, the generator 1009d sets a time period (assertion period) in which an image formation BD signal indicating a specific reflection face (reflection face “1” in this embodiment) is at “L (low level)” to a time period different from a time period in which an image formation BD signal indicating another reflection face is at “L (low level)”. More specifically, as illustrated in FIG. 5, the generator 1009d sets a time period in which an image formation BD signal corresponding to the face number “1” is at “L” to a time period different from time periods for the other face numbers “2”, “3”, and “4”. In this embodiment, a time period ta (assertion period ta), in which the image formation BD signal corresponding to the face number “1” is at “L”, is set to a time period longer than a time period tb (assertion period tb), in which the image formation BD signal corresponding to each of the other face numbers “2”, “3”, and “4” is at “L”. An image formation BD signal having an assertion period longer than other assertion periods is hereinafter referred to as “marking BD”.

In response to (in synchronization with) the BD signal output from the BD sensor 1004, the engine controller 1009 outputs the signal generated by the generator 1009d as the image formation BD signal.

The engine controller 1009 includes a pulse counter 1009f configured to count the number of pulses of the output image formation BD signal. When a signal indicating detection of the leading edge of the recording medium is input from the sheet sensor 726, the engine controller 1009 uses the pulse counter 1009f to start counting of the number of pulses of the output image formation BD signal. When the counted number of pulses has reached the number of pulses corresponding to one page of the recording medium (period Ta), the engine controller 1009 stops drive of the registration rollers 723.

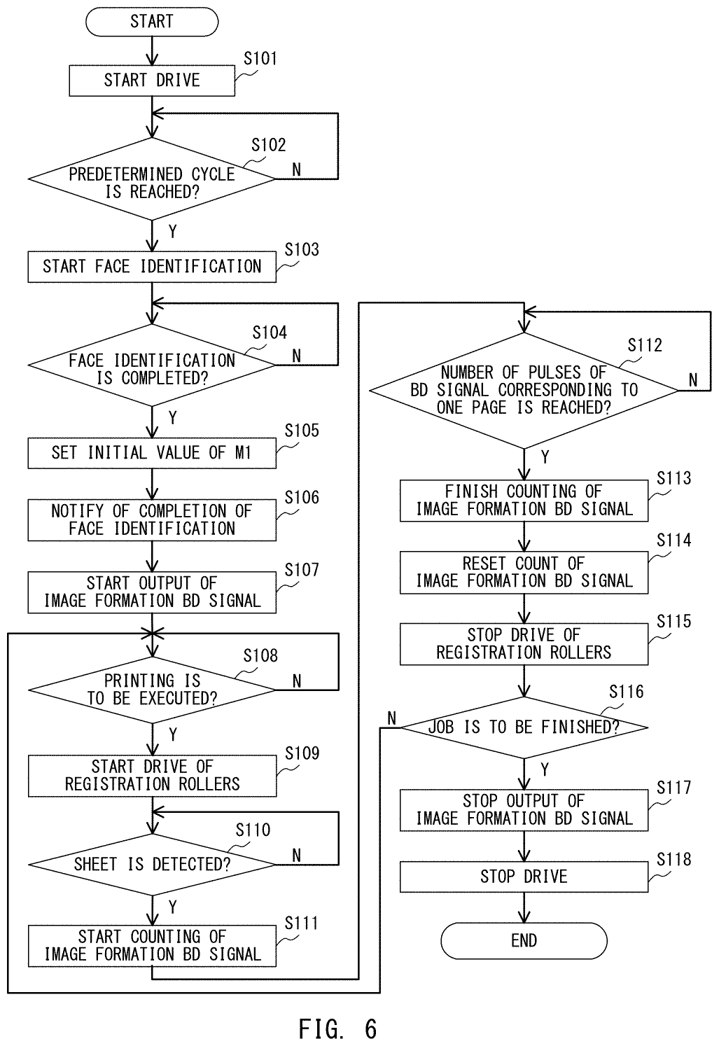

FIG. 6 is a flow chart for illustrating control to be performed by the engine controller 1009 in this embodiment. In the following description, after the face identification is completed, the engine controller 1009 updates the counted number M1 of the face counter 1009b every time the falling edge of the input BD signal is detected.

When the printing job is started, the engine controller 1009 starts drive of the motor (polygon motor) configured to rotationally drive the polygon mirror 1002 (Step S101). When the rotation cycle of the polygon mirror 1002 has become stable at the predetermined cycle (Step S102: Y), the engine controller 1009 starts face identification (time t1) (Step S103). Then, when the engine controller 1009 completes the face identification (time t2), the processing proceeds to Step S105 (Step S104: Y).

The engine controller 1009 sets a face number corresponding to a BD signal that is input first after the identification of the face number is finished, as an initial value of the counted number M1 of the face counter 1009b (Step S105). When the initial value is set, the engine controller 1009 updates the counted number M1 every time the falling edge of the input BD signal is detected. The engine controller 1009 notifies the image controller 1007 via the communication I/F 1009e that the face identification is completed (Step S106). The engine controller 1009 starts output of the image formation BD signal (Step S107).

When receiving from the CPU 151 an instruction to form an image on the recording medium (Step S108: Y), the engine controller 1009 starts drive of the registration rollers 723 (Step S109). As a result, the conveyance of the recording medium is resumed. When the signal indicating detection of the leading edge of the recording medium by the sheet sensor 726 is input to the engine controller 1009 (Step S110: Y), the engine controller 1009 starts counting of the pulse of the output image formation BD signal (Step S111). The engine controller 1009 counts, for example, falling of the pulse of the output image formation BD signal.

When the counted number of pulses has reached the number of pulses corresponding to one page of the recording medium (period Ta) (Step S112: Y), the engine controller 1009 finishes counting of the pulses of the output image formation BD signal (Step S113). The engine controller 1009 then resets the counted number (Step S114). Further, the engine controller 1009 stops drive of the registration rollers 723 (Step S115).

When the printing job is not to be finished, the processing returns to Step S108 again (Step S116: N). When the printing job is to be finished (Step S116: Y), the engine controller 1009 stops output of the image formation BD signal (Step S117), stops drive of the polygon mirror 1002 (Step S118), and ends the processing of the flow chart.

This concludes the control to be performed by the engine controller 1009.

### Image Controller

Next, control to be performed by the image controller 1007 is described. As illustrated in FIG. 3, the image controller 1007 includes the image processor 1010 configured to identify face information for identifying, among a plurality of reflection faces, a reflection face on which the laser beam for scanning the light receiving surface of the BD sensor 1004 is deflected, and correct image data based on the face information. In the following, the function of the image processor 1010 is described.

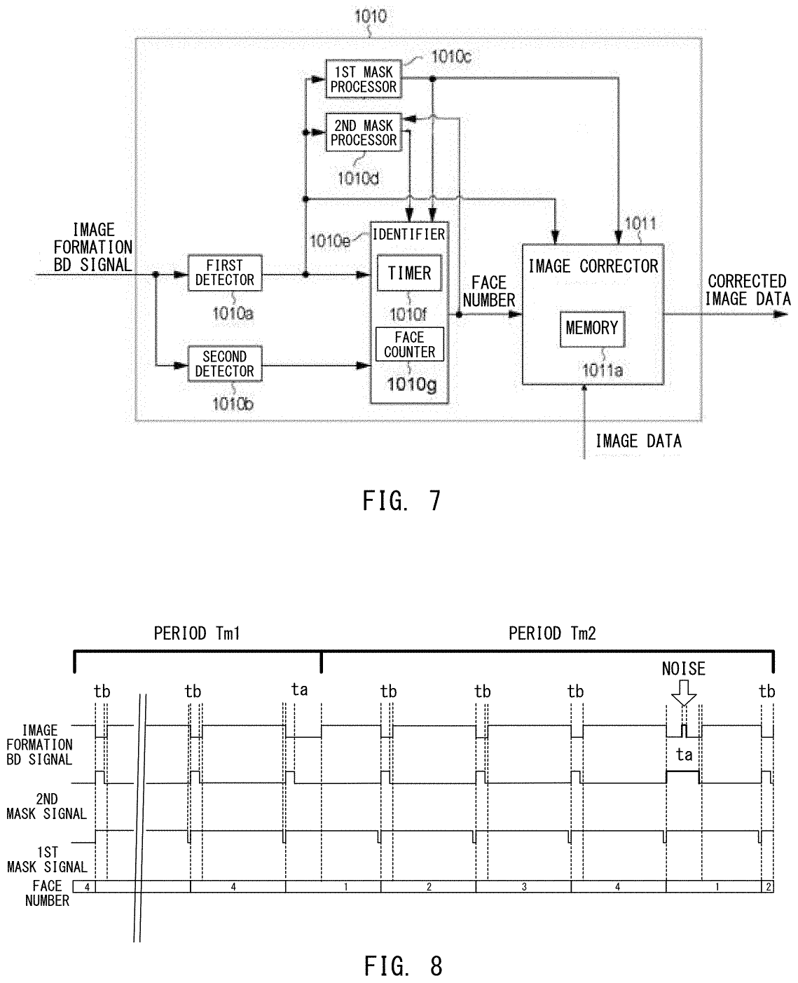

FIG. 7 is a diagram for illustrating a configuration of the image processor 1010. The image processor 1010 includes a first detector 1010a configured to detect a falling edge, which corresponds to a first change, of an input image formation BD signal, and a second detector 1010b configured to detect a rising edge, which corresponds to a second change, of the input image formation BD signal. The image processor 1010 also includes a first mask processor 1010c and a second mask processor 1010d, which are each configured to output a mask signal based on a detection result output from the first detector 1010a. The image processor 1010 includes an identifier 1010e configured to identify, among a plurality of reflection faces, a reflection face on which the laser beam for scanning the light receiving surface of the BD sensor 1004 is deflected. The image processor 1010 includes an image corrector 1011 configured to correct image data based on information on the reflection face identified by the identifier 1010e.

When detecting the falling edge of the input image formation BD signal, the first detector 1010a outputs a signal indicating detection of the falling edge to the first mask processor 1010c, the second mask processor 1010d, the identifier 1010e, and the image corrector 1011.

When detecting the rising edge of the input image formation BD signal, the second detector 1010b outputs a signal indicating detection of the rising edge to the identifier 1010e.

The identifier 1010e includes a timer 1010f configured to measure a time period in which the image formation BD signal is at “L (low level)” based on detection results obtained by the first detector 1010a and the second detector 1010b, and a face counter 1010g configured to store face information indicating an identified reflection face. A counted number M2 of the face counter 1010g corresponds to the face information.

When a signal indicating detection of the falling edge is output from the first detector 1010a, the identifier 1010e resets a time period measured by the timer 1010f. Further, when a signal indicating detection of the rising edge is output from the second detector 1010b, the identifier 1010e stops the timer 1010f.

The identifier 1010e identifies the reflection face based on a measurement result obtained by the timer 1010f. Specifically, when a measured time period t obtained by the timer 1010f is larger than a predetermined time period tc, the identifier 1010e determines that the image formation BD signal input to the image controller 1007 is a signal indicating the face number “1”. The predetermined time period tc is set to a time period shorter than the time period ta, in which the image formation BD signal corresponding to the face number “1” is at “L”, and longer than a time period in which the image formation BD signal corresponding to each of the other face numbers “2”, “3”, and “4” is at “L”.

When determining that the image formation BD signal input to the image controller 1007 is the signal indicating the face number “1”, the identifier 1010e sets the counted number M2 of the face counter 1010g to “1”.

Every time the signal indicating detection of the falling edge is output from the first detector 1010a, the identifier 1010e updates the counted number M2 of the face counter 1010g. The counted number M2 of the face counter 1010g is output to the image corrector 1011 as the face number. When the polygon mirror 1002 has n (n is a positive integer) reflection faces, M2 is a positive integer satisfying 1≤M2≤n.

The image corrector 1011 outputs corrected image data in response to the signal indicating detection of the falling edge being output from the first detector 1010a. A method of correcting image data by the image corrector 1011 is described later.

FIG. 8 is a timing chart of a first mask signal to be output from the first mask processor 1010c and a second mask signal to be output from the second mask processor 1010d.

When the signal indicating detection of the falling edge is output from the first detector 1010a, the first mask processor 1010c sets the first mask signal to “H (high level)”, and outputs the resultant first mask signal to the identifier 1010e and the image corrector 1011. That is, with the output of the signal indicating detection of the falling edge from the first detector 1010a as a start point, the first mask processor 1010c sets the first mask signal to “H” to output the resultant first mask signal. In at least one embodiment, a time period in which the first mask signal is at “H” is set to a time period of 95% of a shortest cycle from among the scanning cycles T1 to T4 corresponding to the respective face numbers.

When the signal indicating detection of the falling edge is output from the first detector 1010a, the second mask processor 1010c sets the second mask signal to “H”, and outputs the resultant second mask signal to the identifier 1010e. That is, with the output of the signal indicating detection of the falling edge from the first detector 1010a as a start point, the second mask processor 1010c sets the second mask signal to “H” to output the resultant second mask signal.

In at least one embodiment, in a period Tm1, which is a time period before the face identification by the identifier 1010e is finished, a time period in which the second mask signal is at “H” is set to a time period of, for example, 95% of the time period tb. This mask signal processing is hereinafter referred to as “mask pattern 1”.

Further, in a period Tm2, which is a time period after the face identification by the identifier 1010e is finished, the time period in which the second mask signal is at “H” is set based on a face number output from the identifier 1010e. Specifically, when the signal indicating detection of the falling edge is output from the first detector 1010a in a case where the face number is “4”, the second mask processor 1010c sets a time period in which the second mask signal is at “H” to a time period corresponding to 95% of the time period ta. Further, when the signal indicating detection of the falling edge is output from the first detector 1010a in a case where the face number is one of “1”, “2”, and “3”, the second mask processor 1010c sets the time period in which the second mask signal is at “H” to a time period corresponding to 95% of the time period tb. This mask signal processing is hereinafter referred to as “mask pattern 2”.

During a period in which the first mask signal is “H”, the identifier 1010e does not update the counted number M2 of the face counter 1010g even when the signal indicating detection of the falling edge is output from the first detector 1010a. As a result, it is possible to prevent a case in which the counted number M2 differs from the reflection face on which the laser beam is deflected because noise is generated during a time period from detection of the falling edge until detection of a falling edge next to this falling edge.

During the period in which the first mask signal is “H”, the image corrector 1011 does not output the image data even when the signal indicating detection of the falling edge is output from the first detector 1010a. As a result, it is possible to prevent a case in which image data is output at timing of falling of the image formation BD signal due to noise.

During a period in which the second mask signal is at “H”, the identifier 1010e does not stop the measurement of a time period by the timer 1010f even when the signal indicating detection of the rising edge is output from the second detector 1010b. Further, during the period in which the first mask signal is at “H”, the identifier 1010e does not reset the time period measured by the timer 1010f even when the signal indicating detection of the falling edge is output from the first detector 1010b.

With this configuration, when a reflection face is to be identified based on a time period in which the image formation BD signal is at “L”, it is possible to prevent erroneous identification of a face number due to noise.

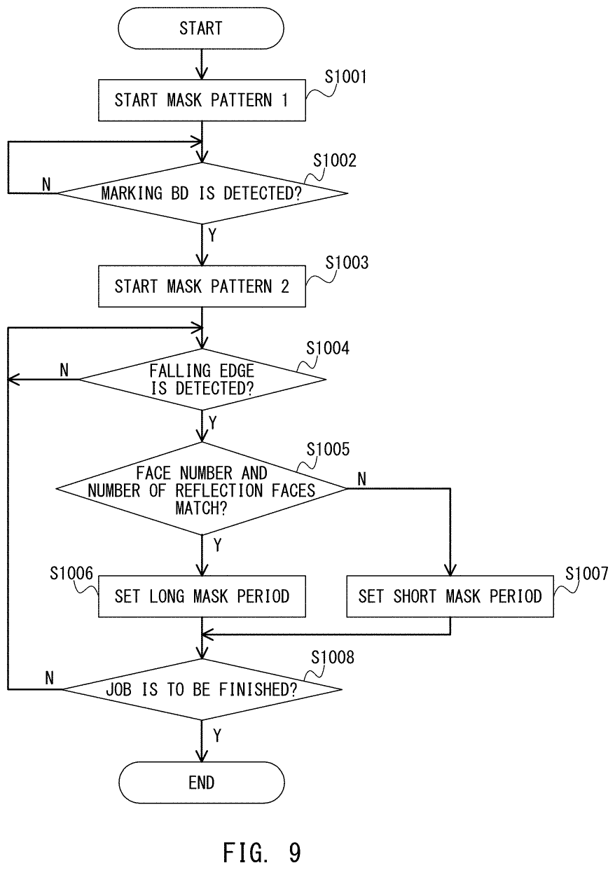

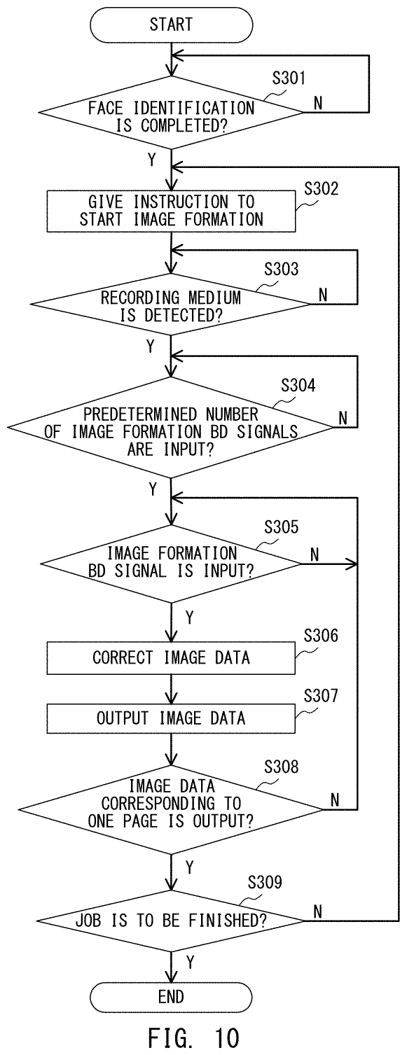

FIG. 9 is a flow chart for illustrating processing for mask signals. This processing is executed by the CPU 151. In the following description, the face number to be output from the face counter 1010g to the image corrector 1011 is updated every time the counted number M2 is updated. Further, during a period in which the processing of the flow chart illustrated in FIG. 9 is executed, the image controller 1007 (image corrector 1011) counts the number of regions of the output image data.

When a job is started, the CPU 151 controls the second mask processor 1010d so as to start the mask pattern 1. As a result, the time period in which the second mask signal is at “H” is set to the time period corresponding to 95% of the time period tb (Step S1001). When the marking BD is detected by the identifier 1010e (Step S1002: Y), the CPU 151 controls the second mask processor 1010d so as to start the mask pattern 2 (Step S1003). After that, when the first detector 1010a detects the falling edge of the image formation BD signal (Step S1004: Y), the processing proceeds to Step S1005.

When the face number of the face counter 1010g and the number of reflection faces of the polygon mirror (4 in at least one embodiment) match (Step S1005: Y), the CPU 151 sets a time period in which the second mask signal is at “H” to a long mask period. That is, the CPU 151 controls the second mask processor 1010d so as to set the time period in which the second mask signal is at “H” to the time period corresponding to 95% of the time period to (Step S1006).

When the face number of the face counter 1010g and the number of reflection faces of the polygon mirror do not match (Step S1005: N), the CPU 151 sets a time period in which the second mask signal is at “H” to a short mask period. That is, the CPU 151 controls the second mask processor 1010d so as to set the time period in which the second mask signal is at “H” to the time period corresponding to 95% of the time period tb (Step S1007).

After the setting of the mask period, the CPU 151 confirms whether or not every print job has been finished (Step S1008). When every print job has not been finished (Step S1008: N), the CPU 151 repeatedly executes the processing of Step S1004 and the subsequent steps. When every print job has been finished (Step S1008: Y), the CPU 151 ends this processing.

As described above, according to at least one embodiment, after the marking BD is detected, the identifier 1010e updates the face number of the face counter 1010g every time the falling edge of the image formation BD signal is detected by the first detector 1010a. Further, the identifier 1010e detects the marking BD even after the marking BD is detected. As a result, even when the detection of the falling edge of the image formation BD signal by the first detector 1010a contains an erroneous detection, the face number is corrected every time the marking BD is detected. As a result, it is possible to prevent a formed latent image from being deformed.

In at least one embodiment, in the period Tm1, which is a time period before the face identification by the identifier 1010e is finished, a time period in which the second mask signal is at “H” is set to a time period of, for example, 95% of the time period tb. Further, in the period Tm2, which is a time period after the face identification by the identifier 1010e is finished, the time period in which the second mask signal is at “H” is set based on a face number output from the identifier 1010e. Specifically, when the signal indicating detection of the falling edge is output from the first detector 1010a in a case where the face number is “4”, the second mask processor 1010c sets a time period in which the second mask signal is at “H” to a time period corresponding to 95% of the time period ta. Further, when the signal indicating detection of the falling edge is output from the first detector 1010a in a case where the face number is one of “1”, “2”, and “3”, the second mask processor 1010c sets the time period in which the second mask signal is at “H” to a time period corresponding to 95% of the time period tb. As a result, it is possible to prevent a case in which a face of the polygon mirror cannot be accurately identified when noise occurs in the image formation BD signal. That is, a reflection face can be determined with high accuracy.

### Timing to Output Image Data

The image controller 1007 outputs corrected image data based on the image formation BD signal input from the engine controller 1009. Specifically, when “y” image formation BD signals (in this embodiment, 10 signals) have been input since the signal indicating detection of the leading edge of the recording medium was output from the sheet sensor 726 (that is, from 11th pulse), the image controller 1007 starts output of the corrected image data. As described above, in this embodiment, when 10 pulses of the image formation BD signal have been output since the sheet sensor 726 detected the leading edge of the recording medium, the corrected image data is started to be output. As a result, the image is formed at a predetermined position of the recording medium.

### Correction of Image Data

The image corrector 1011 serving as a corrector corrects image data in order from image data A, which is the most upstream piece of image data in the sub-scanning direction from among a plurality of pieces of data forming the image corresponding to one page described with reference to FIG. 2. Specifically, for example, when an image corresponding to the image data A is an image formed by the laser beam deflected by the reflection face corresponding to the face number “1”, the image corrector 1011 performs correction corresponding to the face number “1” on the image data A. More specifically, the image corrector 1011 reads out from a memory 1011a correction data corresponding to the face number “1”. Then, the image corrector 1011 corrects the image data A based on the read correction data. After that, the image corrector 1011 corrects the most upstream piece of image data B from among a plurality of pieces of image data on the downstream side of the image data A in the sub-scanning direction, based on correction data corresponding to the face number “2” stored in the memory 1011a. As described above, in the memory 1011a, the correction data corresponding to each face number is stored in association with the face number. With this configuration, a laser beam based on image data corrected through use of correction data corresponding to a face number “m” (m is a positive integer of from 1 to 4) is deflected by a reflection face corresponding to the face number “m”. The image corrector 1011 performs the above-mentioned processing until correction of image data corresponding to one surface of the recording medium is completed.

The image corrector 1011 outputs, to the laser controller 1008 for each region, the image data that has been corrected in the above-mentioned manner for each region in order from the upstream side (that is, from the image data A). The image corrector 1011 outputs one piece of image data to the laser controller 1008 in synchronization with the detection of the falling edge of the image formation BD signal by the first detector 1010a. In at least one embodiment, the image corrector 1011 corrects image data and outputs the corrected image data in synchronization with the detection of the falling edge of the image formation BD signal by the first detector 1010a, but the present disclosure is not limited thereto. For example, the image corrector 1011 may be configured to correct image data based on a face number in advance, and output the corrected image data to the laser controller 1008 in synchronization with the detection of the falling edge of the image formation BD signal by the first detector 1010a.

The image corrector 1011 has built therein a counter (not shown) configured to count the number of pieces of output image data and when the counted number of the counter reaches a value corresponding to one sheet (corresponding to one page) of the recording medium, the image corrector 1011 stops output of the image data.

FIG. 10 is a flow chart for illustrating control to be performed by the image controller 1007. The processing of the flow chart illustrated in FIG. 10 is executed by the CPU 151. During a period in which the processing of the flow chart illustrated in FIG. 10 is executed, the image controller 1007 (image corrector 1011) counts the number of regions of the output image data.

When the face identification is completed (Step S301: Y), the CPU 151 outputs to the engine controller 1009 an instruction to form an image on the recording medium (Step S302). As a result, the engine controller 1009 starts drive of the registration rollers 723. After that, when the signal indicating that the sheet sensor 726 has detected the leading edge of the recording medium is input to the image controller 1007 (Step S303: Y), the CPU 151 advances the processing to Step S304.

When a predetermined number of image formation BD signals (ten image formation BD signals in this embodiment) have been input (when the falling edge of the image formation BD signal has been detected a predetermined number of times) (Step S304: Y), the processing proceeds to Step S305. When the next image formation BD signal (11th image formation BD signal in this embodiment) has been input (Step S305: Y), the CPU 151 controls the image corrector 1011 such that the image corrector 1011 corrects the image data based on the face number (Step S306). As a result, the image corrector 1011 corrects the image data based on the face number. Then, the CPU 151 controls the image corrector 1011 such that the image corrector 1011 outputs the image data corrected in Step S306 to the laser controller 1008 in synchronization with the image formation BD signal (Step S307). As a result, the corrected image data is output to the laser controller 1008 in synchronization with the image formation BD signal.

The image controller 1007 repeatedly performs the processing of from Step S305 to Step S307 until the image data corresponding to one surface (corresponding to one page) of the recording medium is output (Step S308: N). Subsequently, the CPU 151 repeatedly performs the processing described above until the printing job is finished (Step S309).

In at least one embodiment, processing is executed while the assertion period of the image formation BD signal is set to a time period in which the image formation BD signal is at “L”, but processing may also be executed while the assertion period of the image formation BD signal is set to a time period in which the image formation BD signal is at “H”.

In this embodiment, the engine controller 1009 starts counting of the number of pulses of the output image formation BD signal when the output of the image formation BD signal is started, but the present disclosure is not limited thereto. For example, the engine controller 1009 may be configured to start counting of the number of pulses of the output image formation BD signal when the output of the image data from the image controller 1007 to the laser controller 1008 is started.

The laser light source 1000, the polygon mirror 1002, the photosensitive drum 708, the BD sensor 1004, and the engine controller 1009 in this embodiment are included in an image forming unit.

In this embodiment, the image controller 1007 outputs the corrected image data to the laser controller 1008, but the present disclosure is not limited thereto. For example, the image controller 1007 may be configured to output the corrected image data to the engine controller 1009, and the engine controller 1009 may be configured to output the image data to the laser controller 1008. That is, it is only required that the image controller 1007 be configured to output the corrected image data to the image forming unit.

In this embodiment, the sheet sensor 726 is arranged on the upstream side of the transfer position and on the downstream side of the registration rollers 723, but the present disclosure is not limited thereto. For example, the sheet sensor 726 may be arranged on the upstream side of the registration rollers 723.

In this embodiment, as described above with reference to FIG. 4A, FIG. 4B, and FIG. 5, a face number is identified based on the cycle of the BD signal, but a method of identifying a face number is not limited thereto. For example, a face number may be identified based on a phase difference between a signal indicating the rotation cycle of the motor configured to rotationally drive the polygon mirror 1002 (for example, a signal of an encoder or an FG signal) and the BD signal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-152000, filed Aug. 10, 2018 which is hereby incorporated by reference herein in its entirety.

What is claimed is:

1. An information processing apparatus, which is connected to an image forming apparatus including an image forming unit,
the image forming unit comprising:
a first receiver configured to receive image data;
a light source configured to output light based on the image data received by the first receiver;
a photosensitive member;
a rotary polygon mirror having a plurality of reflection faces, wherein the rotary polygon mirror is configured to rotate to deflect the light output from the light source through use of the plurality of reflection faces, to thereby scan the photosensitive member;
a light receiver configured to receive the light deflected by the rotary polygon mirror;
an identifier configured to identify a reflection face that is used for scanning of the photosensitive member from among the plurality of reflection faces based on a result of the reception of the light by the light receiver; and
a generator configured to generate a first signal including a signal having a first level and a signal having a second level, wherein the generator is configured to generate the first signal based on information related to the reflection face identified by the identifier such that a length of a first period differs from a length of a second period, the first period being a period in which the first signal corresponding to a specific reflection face from among the plurality of reflection faces is at the first level, and the second period being a period in which the first signal corresponding to a reflection face other than the specific reflection face is at the first level,
the information processing apparatus comprising:
a second receiver configured to receive the first signal;
a first detector configured to detect a first change, in which a level of the first signal received by the second receiver is changed from the second level to the first level;
a second detector configured to detect a second change, in which the level of the first signal received by the second receiver is changed from the first level to the second level;
a determiner configured to determine, based on a first timing, at which the first change is detected, and a second timing, at which the second change is detected first after a predetermined time period has passed since the first timing, whether the first change at the first timing is a change corresponding to the specific reflection face, wherein the predetermined time period is shorter than the length of the first period and the length of the second period;
a corrector configured to correct, based on a determination result obtained by the determiner, image data corresponding to a scanning line of the light, through use of correction data corresponding to the reflection face corresponding to the scanning line; and
a first output unit configured to output the image data corrected by the corrector to the image forming unit in response to the first detector detecting the first change.

2. The information processing apparatus according to claim 1,
wherein the length of the first period is longer than the length of the second period, and
wherein the determiner is configured to determine that the first change at the first timing is the change corresponding to the specific reflection face when a time period from the first timing to the second timing is longer than a second predetermined time period, which is shorter than the length of the first period and is longer than the length of the second period.

3. The information processing apparatus according to claim 2,
wherein, after the determiner determines that the first change at the first timing is the change corresponding to the specific reflection face, the determiner updates face information indicating one of the plurality of reflection faces every time the first change is detected,
wherein the corrector is configured to correct the image data based on the face information such that the correction corresponds to the one of the plurality of reflection faces, and
wherein the first output unit is configured to output the image data corrected by the corrector to the image forming unit every time the first change is detected.

4. The information processing apparatus according to claim 3, further comprising a second output unit configured to output a second signal in response to detection of the first change,
wherein, after the determiner determines that the first change at the first timing is the change corresponding to the specific reflection face, the determiner avoids updating the face information even when the first change is detected during a period in which the second signal is output, and
wherein the first output unit is configured to avoid outputting the image data corrected by the corrector to the image forming unit even when the first change is detected during the period in which the second signal is output.

5. The information processing apparatus according to claim 1, further comprising a second output unit configured to output a second signal in response to detection of the first change,
wherein a detection result obtained by the first detector during a period in which the second signal is output is inhibited from being used for determination processing to be executed by the determiner.

6. The information processing apparatus according to claim 1,
wherein a first circuit board, on which the second receiver is mounted, differs from a second circuit board, on which the generator is mounted, and
wherein the first circuit board is connected to the second circuit board by a cable.

7. An information processing apparatus, which is connected to an image forming apparatus including an image forming unit,
the image forming unit comprising:
a first receiver configured to receive image data;
a light source configured to output light based on the image data received by the first receiver;
a photosensitive member;
a rotary polygon mirror having a plurality of reflection faces, wherein the rotary polygon mirror is configured to rotate to deflect the light output from the light source through use of the plurality of reflection faces, to thereby scan the photosensitive member;
a light receiver configured to receive the light deflected by the rotary polygon mirror;
an identifier configured to identify a reflection face that is used for scanning of the photosensitive member from among the plurality of reflection faces based on a result of the reception of the light by the light receiver; and
a generator configured to generate a first signal including a signal having a first level and a signal having a second level, wherein the generator is configured to generate the first signal based on information related to the reflection face identified by the identifier such that a length of a first period differs from a length of a second period, the first period being a period in which the first signal corresponding to a specific reflection face from among the plurality of reflection faces is at the first level, and the second period being a period in which the first signal corresponding to a reflection face other than the specific reflection face is at the first level,
the information processing apparatus comprising:
a second receiver configured to receive the first signal;
a first detector configured to detect a first change, in which a level of the first signal received by the second receiver is changed from the second level to the first level;
a second detector configured to detect a second change, in which the level of the first signal received by the second receiver is changed from the first level to the second level;
a first output unit configured to output a second signal in response to detection of the first change;
a determiner configured to determine, based on a first timing, at which the first change is detected, and a second timing, at which the second change is detected first since a stop of output of the first timing, whether the first change at the first timing is a change corresponding to the specific reflection face, wherein a time period in which output of the second signal is continued is shorter than the length of the first period and the length of the second period;
a corrector configured to correct, based on a determination result obtained by the determiner, image data corresponding to a scanning line of the light, through use of correction data corresponding to the reflection face corresponding to the scanning line; and
a second output unit configured to output the image data corrected by the corrector to the image forming unit in response to the first detector detecting the first change.

8. The information processing apparatus according to claim 7,
wherein the length of the first period is longer than the length of the second period, and
wherein the determiner is configured to determine that the first change at the first timing is the change corresponding to the specific reflection face when a time period from the first timing to the second timing is longer than a predetermined time period, which is shorter than the length of the first period and is longer than the length of the second period.

9. The information processing apparatus according to claim 8,
wherein, after the determiner determines that the first change at the first timing is the change corresponding to the specific reflection face, the determiner updates face information indicating one of the plurality of reflection faces every time the first change is detected,
wherein the corrector is configured to correct the image data based on the face information such that the correction corresponds to the one of the plurality of reflection faces, and
wherein the second output unit is configured to output the image data corrected by the corrector to the image forming unit every time the first change is detected.

10. The information processing apparatus according to claim 9, wherein, before the first change at the first timing is determined as being the change corresponding to the specific reflection face, the first output unit outputs the second signal for a second predetermined time period since the detection of the first change, and, after the first change at the first timing is determined as being the change corresponding to the specific reflection face, outputs the second signal for a time period corresponding to the face information, the second predetermined time period being shorter than the length of the first period and the length of the second period.

11. The information processing apparatus according to claim 7,
wherein a detection result obtained by the second detector during a period in which the second signal is output is inhibited from being used for determination processing to be executed by the determiner.

12. The information processing apparatus according to claim 9, further comprising a third output unit configured to output a third signal in response to detection of the first change for a third predetermined time period,
wherein, after the determiner determines that the first change at the first timing is the change corresponding to the specific reflection face, the determiner avoids updating the face information even when the first change is detected during a period in which the third signal is output, and
wherein the second output unit is configured to avoid outputting the image data corrected by the corrector to the image forming unit even when the first change is detected during the period in which the third signal is output.

13. The information processing apparatus according to claim 7, further comprising a third output unit configured to output a third signal for a third predetermined time in response to detection of the first change,
wherein a detection result obtained by the first detector during a period in which the second signal is output is inhibited from being used for determination processing to be executed by the determiner.

14. The information processing apparatus according to claim 7,
wherein a first circuit board, on which the second receiver is mounted, differs from a second circuit board, on which the generator is mounted, and
wherein the first circuit board is connected to the second circuit board by a cable.

15. An image forming apparatus including a first generator which generates image data and an image forming unit which forms an image on a recording medium based on the image data output from the first generator,
the image forming unit comprising:
a first receiver configured to receive image data;
a light source configured to output light based on the image data received by the first receiver;
a photosensitive member;
a rotary polygon mirror having a plurality of reflection faces, wherein the rotary polygon mirror is configured to rotate to deflect the light output from the light source through use of the plurality of reflection faces, to thereby scan the photosensitive member;
a light receiver configured to receive the light deflected by the rotary polygon mirror;
an identifier configured to identify a reflection face that is used for scanning of the photosensitive member from among the plurality of reflection faces based on a result of the reception of the light by the light receiver; and
a second generator configured to generate a first signal including a signal having a first level and a signal having a second level, wherein the second generator is configured to generate the first signal based on information related to the reflection face identified by the identifier such that a length of a first period differs from a length of a second period, the first period being a period in which the first signal corresponding to a specific reflection face from among the plurality of reflection faces is at the first level, and the second period being a period in which the first signal corresponding to a reflection face other than the specific reflection face is at the first level,
the first generator comprising:
a second receiver configured to receive the first signal;
a first detector configured to detect a first change, in which a level of the first signal received by the second receiver is changed from the second level to the first level;
a second detector configured to detect a second change, in which the level of the first signal received by the second receiver is changed from the first level to the second level;
a determiner configured to determine, based on a first timing, at which the first change is detected, and a second timing, at which the second change is detected first after a predetermined time period has passed since the first timing, whether the first change at the first timing is a change corresponding to the specific reflection face, wherein the predetermined time period is shorter than the length of the first period and the length of the second period;
a corrector configured to correct, based on a determination result obtained by the determiner, image data corresponding to a scanning line of the light, through use of correction data corresponding to the reflection face corresponding to the scanning line; and
a first output unit configured to output the image data corrected by the corrector to the image forming unit in response to the first detector detecting the first change.

16. An image forming apparatus including a first generator which generates image data and an image forming unit which forms an image on a recording medium based on the image data output from the first generator,
the image forming unit comprising:
a first receiver configured to receive image data;
a light source configured to output light based on the image data received by the first receiver;
a photosensitive member;
a rotary polygon mirror having a plurality of reflection faces, wherein the rotary polygon mirror is configured to rotate to deflect the light output from the light source through use of the plurality of reflection faces, to thereby scan the photosensitive member;
a light receiver configured to receive the light deflected by the rotary polygon mirror;
an identifier configured to identify a reflection face that is used for scanning of the photosensitive member from among the plurality of reflection faces based on a result of the reception of the light by the light receiver; and
a second generator configured to generate a first signal including a signal having a first level and a signal having a second level, wherein the second generator is configured to generate the first signal based on information related to the reflection face identified by the identifier such that a length of a first period differs from a length of a second period, the first period being a period in which the first signal corresponding to a specific reflection face from among the plurality of reflection faces is at the first level, and the second period being a period in which the first signal corresponding to a reflection face other than the specific reflection face is at the first level,
the first generator comprising:
a second receiver configured to receive the first signal;
a first detector configured to detect a first change, in which a level of the first signal received by the second receiver is changed from the second level to the first level;
a second detector configured to detect a second change, in which the level of the first signal received by the second receiver is changed from the first level to the second level;
a first output unit configured to output a second signal in response to detection of the first change;
a determiner configured to determine, based on a first timing, at which the first change is detected, and a second timing, at which the second change is detected first since a stop of output of the first timing, whether the first change at the first timing is a change corresponding to the specific reflection face, wherein a time period in which output of the second signal is continued is shorter than the length of the first period and the length of the second period;
a corrector configured to correct, based on a determination result obtained by the determiner, image data corresponding to a scanning line of the light, through use of correction data corresponding to the reflection face corresponding to the scanning line; and
a second output unit configured to output the image data corrected by the corrector to the image forming unit in response to the first detector detecting the first change.
